(19) United States
(12) Patent Application Publication
(10) Pub. No.: US 2007/0254499 A1
(43) Pub. Date: Nov. 1, 2007

(54) Electrical connector

(75) Inventor: Ted Ju, Keelung (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: LOTES Co., Ltd.

(21) Appl. No.: 11/414,312

(22) Filed: May 1, 2006

(51) Int. Cl. H01R 12/00

(52) U.S. Cl. 439/66

(57) ABSTRACT

An electrical connector includes an insulating body provided with a plurality of receiving chambers, each of which is provided with an arc contact face on at least one of its sides; and at least one electrical terminal received in the receiving chamber to deformingly contact with the arc contact face. Compared with the conventional prior art, the structure of the electrical connector according to the present invention can have lower stress concentration, less elastic fatigue, and higher normal force for the electrical terminal.

### FIELD OF THE INVENTION

The present invention relates to an electrical connector, and more particularly, to an electrical connector which can enhance deforming contact between the electrical terminal and the insulating body.

### BACKGROUND OF THE INVENTION

The conventional prior art of electrical connector, PRC Patent No., CN200420088694.0 for example, discloses an electrical connector, as shown in FIG. 1, comprising an insulating body 1 provided with a plurality of receiving chambers 10, and an electrical terminal 2 received in the insulating body 1, wherein the wall of the receiving chamber 10 comprising a vertical portion 100 and an inclined portion 101. The electrical terminal 2 has a certain extent of elasticity and is of a straight shape. The electrical terminal 2 arranged in the insulating body 1 of the electrical connector is retained by a stop block 11, wherein both ends of the electrical terminal 2 protrude over the upper and lower surfaces of the insulating body 1 to form contact terminals 21 and 22. When the electrical terminal 2 is being clamped to deform, as shown 2* in FIG. 2, it will be abutted against the interface between the inclined portion 101 of the receiving chamber 10 and the insulating body 1. However, the kind of electrical terminal structure tends to suffer from elastic fatigue and the electrical terminal is encountered with higher stress concentration as well as lower normal force.

Consequently, it is necessary to design a new type of electrical connector to overcome the shortcomings described above.

### SUMMARY OF THE INVENTION

An object of the present invention is to provide an electrical connector in which the deforming contact between the electrical terminal and the insulating body can be enhanced.

To achieve the object described above, the electrical connector comprises an insulating body provided with a plurality of receiving chambers, each of which is provided with an arc contact face on at least one of its sides; and at leas one electrical terminal received in the receiving chamber to deformingly contact with the arc contact face.

Compared with the conventional prior art, the electrical connector according to the present invention has the advantages described below. The structure of the electrical connector according to the present invention can have lower stress concentration, less elastic fatigue, and higher normal force for the electrical terminal.

### BRIEF DESCRIPTION OF THE DRAWINGS

The present invention can be more fully understood by reference to the following description and accompanying drawings, in which:

FIG. 1 schematically illustrates the local cross-sectional view of the conventional electrical terminal and electrical connector;

FIG. 2 schematically illustrates the perspective view of a preferred embodiment of the terminal receiving chamber of the electrical connector according to the present invention;

FIG. 3 schematically illustrates the perspective view of a preferred embodiment of the electrical connector according to the present invention;

FIG. 4 schematically illustrates the perspective assembly view of the terminal receiving chamber and electrical terminal according to the present invention;

FIG. 5 schematically illustrates the perspective assembly view of FIG. 4 from another view angle;

FIG. 6 schematically illustrates the front view of the terminal receiving chamber with arc contact face and the electrical terminals according to present invention; and

FIG. 7 schematically illustrates the perspective view of another preferred embodiment of the electrical connector according to the present invention.

TABLES 1 and 2 illustrates the elastic fatigue and the normal force of the electrical terminal with R=5.5 mm, respectively;

TABLES 3 and 4 illustrates the elastic fatigue and the normal force of the electrical terminal with R=6.0 mm, respectively;

TABLES 5 and 6 illustrates the elastic fatigue and the normal force of the electrical terminal with R=6.5 mm, respectively;

TABLES 7 and 8 illustrates the elastic fatigue and the normal force of the electrical terminal without arc face, respectively; and

TABLE 9 summarizes all the data in TABLES 1 to 9.

### DETAILED DESCRIPTION OF THE INVENTION

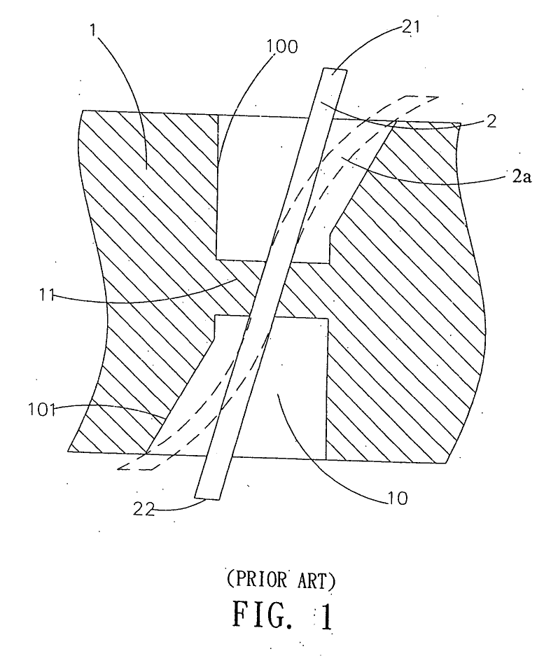

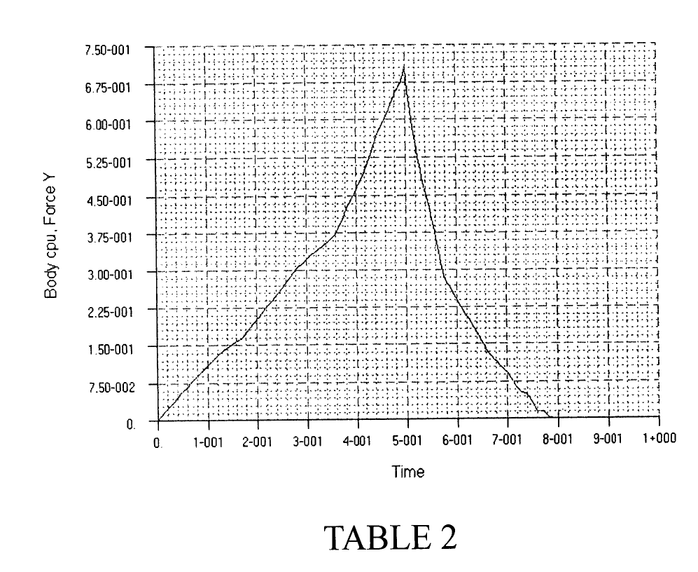

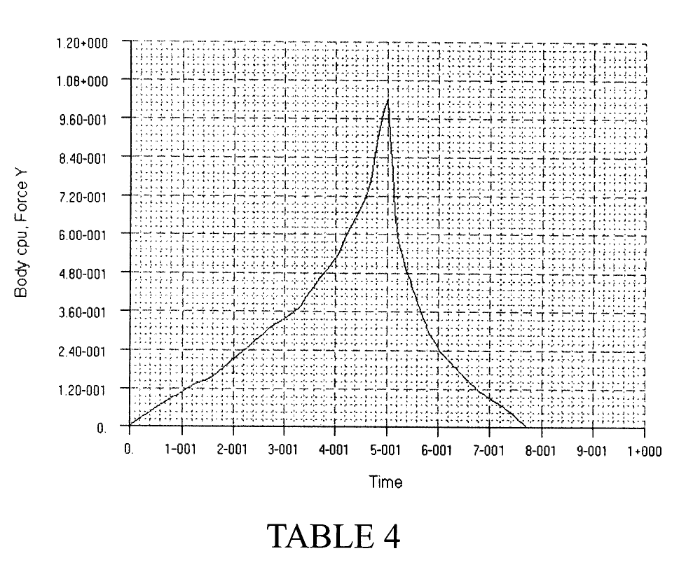

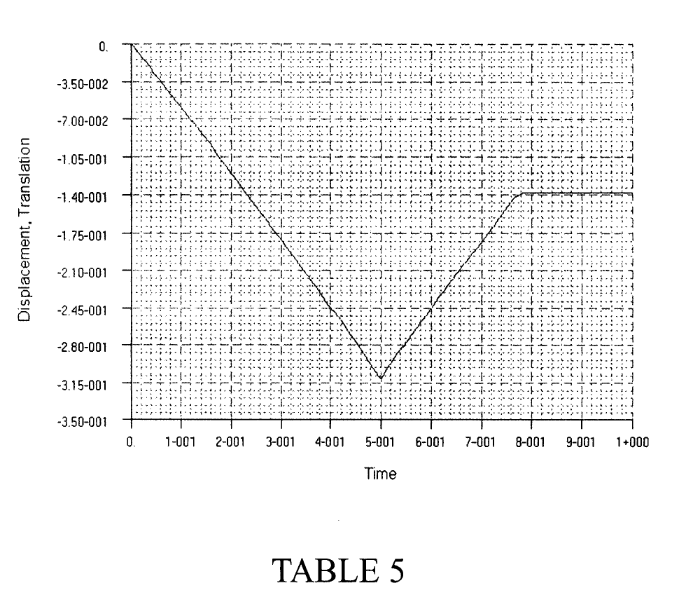

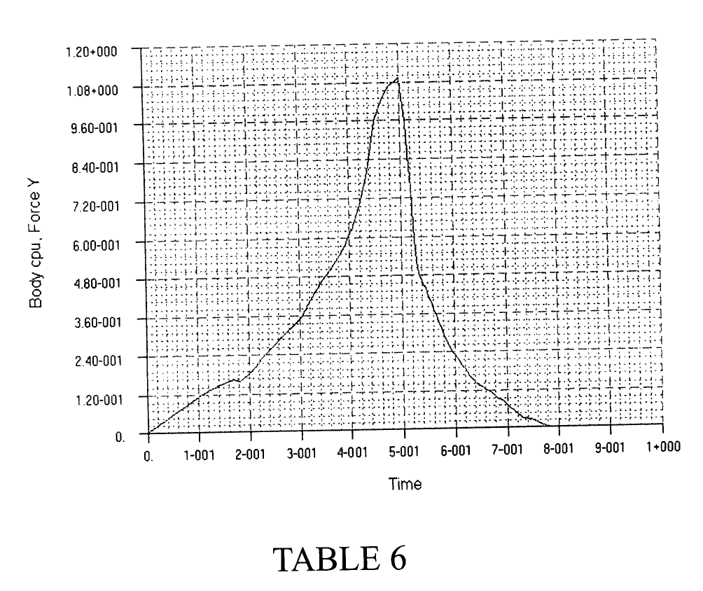

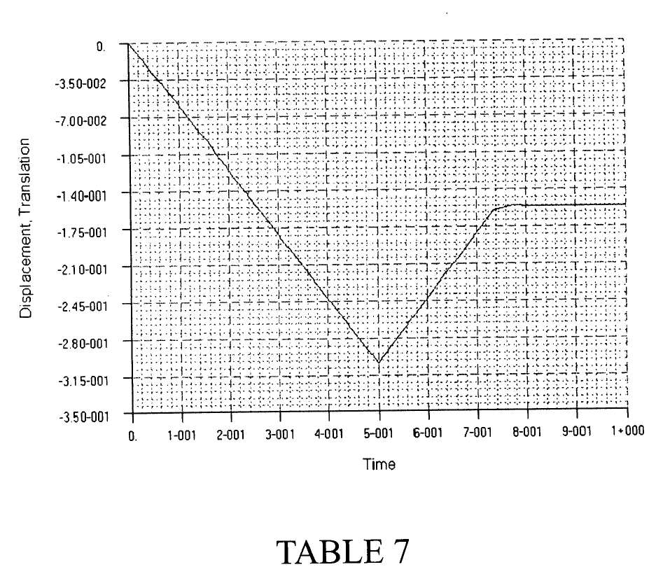

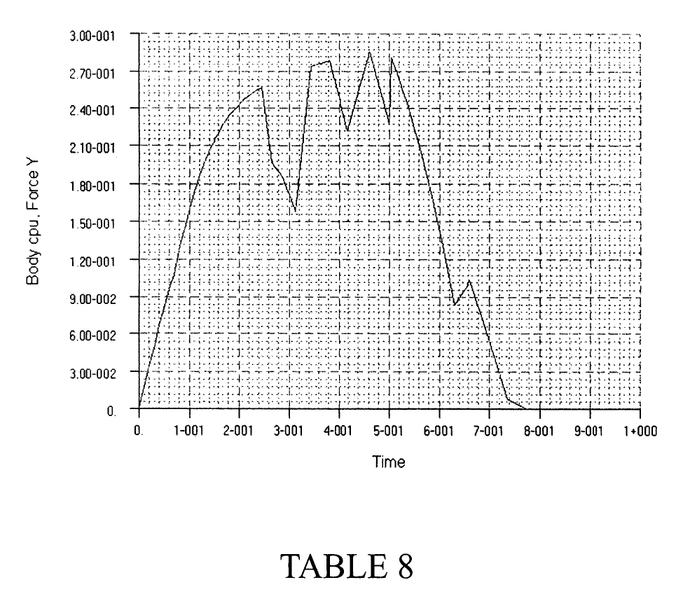

Referring to FIGS. 1 to 6, the electrical connector according to the present invention comprises a plurality of insulating bodies 10 and electrical terminals 20 provided in the insulating body 10, respectively.

The insulating body 10 comprises a receiving chamber 100 and two locating grooves 101, wherein at least one contact face 1000 is provided on one of its sides the receiving chamber 100. The contact face 1000 is, for example but not limited to, arc shape. The electrical terminal 20 is deformingly contacted with the arc contact face 1000 of the receiving chamber 1000 to evenly distribute the stress resulted from the deformation of the electrical terminal 20. Furthermore, the two locating grooves 101 are separated by a separating block 102, and the locating grooves 101 and the receiving chamber 100 is connected.

In particular, the radial normal force increases when the curvature of the arc contact face 1000 of the receiving chamber 100 is increased. The explanation is described below and more insight can be gained by referring to TABLES 1 to 9 (TABLES 1 and 2 illustrate the elastic fatigue and the normal force of the electrical terminal with R=5.5 mm, respectively; TABLES 3 and 4 illustrate the elastic fatigue and the normal force of the electrical terminal with R=6.0 mm, respectively; TABLES 5 and 6 illustrate the elastic fatigue and the normal force of the electrical terminal with R=6.5 mm, respectively. Furthermore, TABLES 7 and 8 illustrate the elastic fatigue and the normal force of the electrical terminal without arc face, respectively. TABLE 9 summarizes all the data described above.).

The electrical terminal 20 is in general a bended plate, comprising an elastic arm 200 and a fastening hook portion 201 extending from the elastic arm 200 thereunder, wherein the extent of bending of the elastic arm 200 after being clamped is determined by the curvature of the contact face. Also, the elastic arm 200 bends upwards to extendingly form a contact portion 210 and extends downwards to form a guiding connection portion 220. A fastening hook 230 is provided on the fastening hook portion 201 thereunder. Furthermore, between the fastening hook portion 201 and the guiding connection portion 220 is cut to form a groove 240, which can receive the separating block 102. After the electrical connector is being assembled, the fastening hook 230 can be hooked onto the lower surface of the separating block 102.

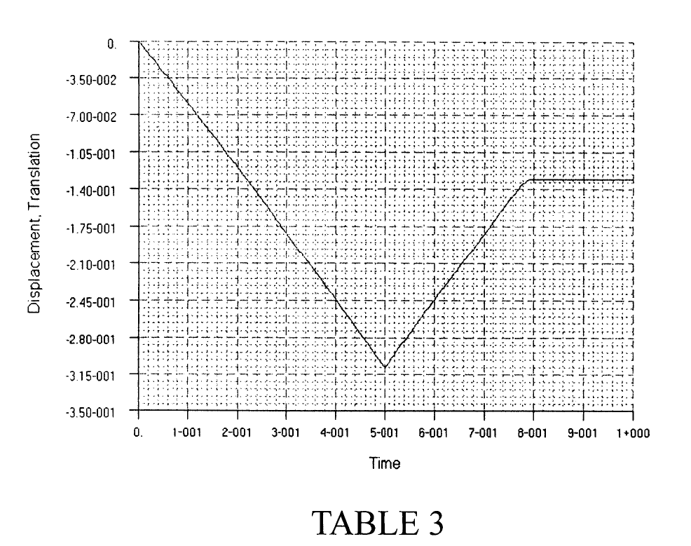

The shape of the lower part of the electrical terminal 20, of course, is not limited to that shown in FIG. 2.

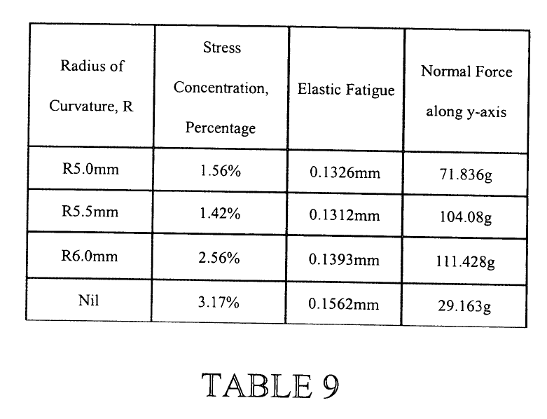

FIG. 7 schematically illustrates another embodiment of the electrical terminal of the electrical connector according to the present invention. The present embodiment differs from the first embodiment in that the contact face of the receiving chamber 11a is provided with at least a step 1001. (In the present embodiment, the contact face is provided with, for example but not limited to, two steps 1001 for explanation, and the two steps 1001 and the electrical terminal 20 form three contact points, which are connected to form an arc shape.) Consequently, the electrical terminal 20 can have lower stress concentration, less elastic fatigue, and higher normal force.

Consequently, by putting the electrical connector according to the present invention into practice, the electrical connector comprises an insulating body provided with a plurality of terminal receiving chambers and electrical terminals received separately in the electrical terminals. The receiving chamber is provided with an arc contact face on at least one of its sides contact face. The electrical terminal is deformingly contacted with the contact face. Consequently, the drawbacks of the conventional prior art of electrical connector can indeed be overcome.

While the invention has been described with reference to the a preferred embodiment thereof, it is to be understood that modifications or variations may be easily made without departing from the spirit of this invention, which is defined by the appended claims.

1. An electrical connector, comprising:
an insulating body provided with a plurality of receiving chambers, each of which is provided with an arc contact face on at least one of its sides; and
at least one electrical terminal received in the receiving chamber to deformingly contact with the arc contact face, wherein an extent of bending of the at least one electrical terminal after being clamped is directly determined by the at least one electrical terminal substantially conforming to a curvature of the arc contact face.

2. (canceled)

3. The electrical connector as defined in claim 1, wherein a radial normal force increases when a curvature of the arc contact face of the receiving chamber is increased.

4. The electrical connector as defined in claim 1, wherein the electrical terminal is in general in a plate shape.

5. The electrical connector as defined in claim 1, wherein the electrical terminal is provided with an elastic arm bending upwards to extendingly form a contact portion and downwards to extendingly form a guiding connection portion.

6. The electrical connector as defined in claim 5, wherein the electrical connector further comprises a fastening hook portion extending from the elastic arm thereunder, wherein a groove is provided between the fastening hook portion and the guiding connection portion.

7. (canceled)

8. The electrical connector as defined in claim 6, wherein a fastening hook is provided on the fastening hook portion thereunder, which is hooked onto a lower surface of the insulating body.

9. The electrical connector as defined in claim 8, wherein the insulating body is provided with a locating groove, which can work together with the fastening hook to retain the electrical terminal.

10. The electrical connector as defined in claim 5, wherein the contact portion protrudes over an upper surface of the insulating body.

11. An electrical connector, comprising:
an insulating body provided with a plurality of receiving chambers, each of which is provided with an arc contact face on at least one of its sides and the contact face is provided with at least a step thereunder; and
at least an electrical terminal received in the receiving chamber, wherein the step and the electrical terminal can form a plurality of contact points, which are connected to form an arch shape, wherein an extent of bending of the electrical terminal after being clamped is directly determined by the at least one electrical terminal substantially conforming to a curvature of the arc contact face.

12. (canceled)

13. The electrical connector as defined in claim 11, wherein a radial normal force increases when a curvature of the arc contact face of the receiving chamber is increased.

14. The electrical connector as defined in claim 11, wherein the electrical terminal is in general in a plate shape.

15. The electrical connector as defined in claim 11, wherein the electrical terminal is provided with an elastic arm bending upwards to extendingly form a contact portion and downwards to extendingly form a guiding connection portion.

16. The electrical connector as defined in claim 15, wherein the electrical connector further comprises a fastening hook portion extending from the elastic arm thereunder, wherein a groove is provided between the fastening hook portion and the guiding connection portion.

17. (canceled)

18. The electrical connector as defined in claim 16, wherein a fastening hook is provided on the fastening hook portion thereunder, which is hooked onto a lower surface of the insulating body.

19. The electrical connector as defined in claim 18, wherein the insulating body is provided with a locating groove, which can work together with the fastening hook to retain the electrical terminal.

20. The electrical connector as defined in claim 15, wherein the contact portion protrudes over an upper surface of the insulating body.
